(19) United States
(12) Patent Application Publication
(10) Pub. No.: US 2024/0278616 A1
(43) Pub. Date: Aug. 22, 2024

(54) VEHICLE AIR CONDITIONING APPARATUS

(71) Applicant: SUBARU CORPORATION, Tokyo (JP)

(72) Inventors: Takako MIZUNO, Tokyo (JP); Masahiko IKEO, Tokyo (JP); Naoyuki OGAWA, Tokyo (JP); Masanori YAMAMOTO, Tokyo (JP); Noriaki AKAI, Tokyo (JP)

(21) Appl. No.: 18/433,914

(22) Filed: Feb. 6, 2024

(30) Foreign Application Priority Data
Feb. 16, 2023 (JP) 2023-022586

(51) Int. Cl. B60H 1/00

(52) U.S. Cl. CPC B60H 1/00064; B60H 1/00285; B60H 1/00742

(57) ABSTRACT

A vehicle air conditioning apparatus includes a seat, an air conditioner, an occupant detector, an air-conditioning air outlet, and a calculation processor. The seat includes a first seat and a second seat. The air-conditioning air outlet includes a first outlet provided in vicinity of the first seat and a second outlet provided in vicinity of the second seat. When determining that the occupant is not present in the second seat based on an output from the occupant detector, the calculation processor sends out first air-conditioning air from the first outlet into a vehicle compartment and send out second air-conditioning air from the second outlet into the vehicle compartment. The first air-conditioning air is conditioned to be at a first temperature. The second air-conditioning air is conditioned to be at a second temperature set to increase an air conditioning effect.

### CROSS-REFERENCE TO RELATED APPLICATIONS

The present application claims priority from Japanese Patent Application No. 2023-022586 filed on Feb. 16, 2023, the entire contents of which are hereby incorporated by reference.

### BACKGROUND

The disclosure relates to a vehicle air conditioning apparatus.

One technique related to an existing vehicle air conditioning apparatus sends driver's seat-side air-conditioning air to a driver's seat side and sends passenger seat-side air-conditioning air to a passenger seat side to cause a temperature of the driver's seat-side air-conditioning air and a temperature of the passenger seat-side air-conditioning air to be different from each other. For example, reference is made to a description of display and switches related to air conditioning in page 488 of LEGACY, OUTBACK, owner's manual available from SUBARU CORPORATION, searched on Sep. 31, 2022. Such a technique allows for individual setting of the driver's seat-side air-conditioning air and the passenger seat-side air-conditioning air. Therefore, also when a temperature felt by a driver and a temperature felt by an occupant in a passenger seat are different from each other, appropriately configuring air conditioning setting for each of the driver and the occupant in the passenger seat makes it possible to secure comfort for both the driver and the occupant in the passenger seat.

In addition, one technique performs air conditioning focused on the vicinity of a driver's seat when a driver is present in a vehicle and no other occupant is present in the vehicle. For example, reference is made to Japanese Unexamined Patent Application Publication (JP-A) No. 2012-001200. In the technique disclosed in JP-A No. 2012-001200, first, a determination is made that an occupant is present in the driver's seat and no occupant is present in other seats. Thereafter, when a heating operation determination unit determines that a heating condition is satisfied, an air temperature adjustment mechanism including independent air mix doors is controlled to cause a temperature of air blowing toward the passenger seat side to be lower than a temperature of air blowing toward the driver's seat side. This makes it possible to cause a heat dissipation amount of a vehicle air conditioning apparatus in a part other than the driver's seat, such as a passenger seat, to be less than that for the driver. In addition, it is possible to reduce an amount of heating of the vehicle as a whole while preferentially performing heating for the driver to improve fuel economy of the vehicle.

### SUMMARY

An aspect of the disclosure provides a vehicle air conditioning apparatus that includes a seat, an air conditioner, an occupant detector, an air-conditioning air outlet, and a calculation processor. The seat includes a first seat and a second seat. The air conditioner is configured to generate first air-conditioning air and second air-conditioning air by conditioning air supplied to a vehicle compartment. The occupant detector is configured to detect whether an occupant is present in the second seat. The air-conditioning air outlet includes a first outlet that is provided in the vicinity of the first seat and from which the first air-conditioning air is to be sent out into the vehicle compartment and a second outlet that is provided in the vicinity of the second seat and from which the second air-conditioning air is to be sent out into the vehicle compartment. The calculation processor is configured to, when determining that the occupant is not present in the second seat based on an output from the occupant detector, send out the first air-conditioning air from the first outlet into the vehicle compartment and send out the second air-conditioning air from the second outlet into the vehicle compartment. The first air-conditioning air is conditioned to be at a first temperature. The second air-conditioning air is conditioned to be at a second temperature set to increase an air conditioning effect.

An aspect of the disclosure provides a vehicle air conditioning apparatus that includes a seat, an air conditioner, an occupant detector, an air-conditioning air outlet, and circuitry. The seat includes a first seat and a second seat. The air conditioner is configured to generate first air-conditioning air and second air-conditioning air by conditioning air supplied to a vehicle compartment. The occupant detector includes a sensor and is configured to detect whether an occupant is present in the second seat. The air-conditioning air outlet includes a first outlet that is provided in the vicinity of the first seat and from which the first air-conditioning air is sent out into the vehicle compartment and a second outlet that is provided in the vicinity of the second seat and from which the second air-conditioning air is sent out into the vehicle compartment. The circuitry is configured to, when determining that the occupant is not present in the second seat based on an output from the occupant detector, send out the first air-conditioning air from the first outlet into the vehicle compartment and send out the second air-conditioning air from the second outlet into the vehicle compartment. The first air-conditioning air is conditioned to be at a first temperature. The second air-conditioning air is conditioned to be at a second temperature set to increase an air conditioning effect.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a vehicle including a vehicle air conditioning apparatus according to one example embodiment of the disclosure, viewed from top.

FIG. 2 is a schematic diagram illustrating a configuration of the vehicle air conditioning apparatus according to one example embodiment of the disclosure.

FIG. 3 is a diagram illustrating an operation to be performed by the vehicle air conditioning apparatus according to one example embodiment of the disclosure in an all-seat air-conditioning mode, viewed from the top.

FIG. 4 is a diagram illustrating an operation to be performed by the vehicle air conditioning apparatus according to one example embodiment of the disclosure in a front-seat air-conditioning mode, viewed from the top.

FIG. 5 is a diagram illustrating an operation to be performed by the vehicle air conditioning apparatus according to one example embodiment of the disclosure in a focused air-conditioning mode, viewed from the top.

FIG. 6 is a diagram illustrating an operation to be performed by the vehicle air conditioning apparatus according to one example embodiment of the disclosure in a driver's seat air-conditioning mode, viewed from the top.

FIG. 7 is a flowchart illustrating an operation to be performed by the vehicle air conditioning apparatus according to one example embodiment of the disclosure in the focused air-conditioning mode.

FIG. 8 is a flowchart illustrating an operation to be performed by the vehicle air conditioning apparatus according to one example embodiment of the disclosure in the focused air-conditioning mode.

FIG. 9A is a diagram illustrating a display state of a display of the vehicle air conditioning apparatus according to one example embodiment of the disclosure.

FIG. 9B is a diagram illustrating another display state of the display of the vehicle air conditioning apparatus according to one example embodiment of the disclosure.

### DETAILED DESCRIPTION

There is still room for improvement in terms of more effective and focused air conditioning regarding respective techniques disclosed in a description of display and switches related to air conditioning in page 488 of LEGACY, OUTBACK, owner's manual available from SUBARU CORPORATION, searched on Sep. 31, 2022 and JP-A No. 2012-001200.

For example, with the use of the technique disclosed in the above-described description of the display and the switches related to the air conditioning in page 488 of LEGACY, OUTBACK, owner's manual, if focused air conditioning is to be performed simply by driver's seat-side air-conditioning air, it may be difficult to perform sufficient air conditioning of the vicinity of a driver's seat in some cases. To address this issue, for example, passenger seat-side air-conditioning air may be sent as auxiliary air upon performing the focused air conditioning. However, because a set temperature of the driver's seat-side air-conditioning air and a set temperature of the passenger seat-side air-conditioning air may be different from each other, it may be difficult to improve efficiency of the focused air conditioning by simply sending the passenger seat-side air-conditioning air. Moreover, simply sending the passenger seat-side air-conditioning air can increase energy loss.

It is desirable to provide a vehicle air conditioning apparatus configured to effectively perform focused air conditioning.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

In the following, a vehicle air conditioning apparatus 11 according to an example embodiment of the disclosure and a vehicle 10 will be described in detail based on the drawings. In the following description, front, rear, upper, lower, left, and right directions are used. As used herein, the left direction and the right direction may be those in a situation where the vehicle 10 is viewed from a rear side thereof. Further, in the following description, substantially identical members are basically denoted by the same reference numeral, and will not be described repeatedly. Further, in the following description, a case in which a driver's seat 121A is disposed on the left side is exemplified; however, the example embodiment of the disclosure is applicable also to a case in which the driver's seat 121A is disposed on the right side in accordance with the laws and regulations of each country. Further, in the following description, a first temperature Tp1 and a second temperature Tp2 may each be a set temperature.

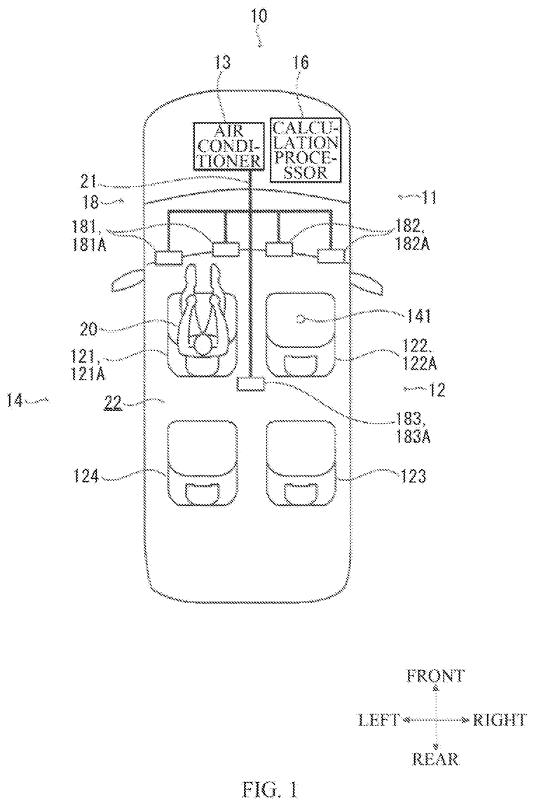

FIG. 1 is a diagram illustrating the vehicle 10 including the vehicle air conditioning apparatus 11, viewed from top. FIG. 1 illustrates a case where an occupant 20 is seated in the driver's seat 121A, and no occupant 20 is seated in a passenger seat 122A. In the example embodiment, being seated may be one example form of being present.

The vehicle air conditioning apparatus 11 may include, for example, a seat 12, an air conditioner 13, an occupant detector 14, an air-conditioning air outlet 18, and a calculation processor 16. The vehicle air conditioning apparatus 11 may be configured to secure comfort in a vehicle compartment 22 and reduce energy consumption based on a situation in which the occupant 20 is present in the vehicle 10, as will be described later.

The vehicle 10 may be, for example, any vehicle such as an engine vehicle, an electric vehicle (EV), a hybrid electric vehicle (HEV), or a plug-in hybrid electric vehicle (PHEV).

The seat 12 may include a first seat 121 and a second seat 122. The first seat 121 may be, for example, the driver's seat 121A, and may be provided at a front-left position inside the vehicle compartment 22. The second seat 122 may be, for example, the passenger seat 122A, and may be provided at a front-right position inside the vehicle compartment 22. The seat 12 may further include a rear seat 123 and a rear seat 124.

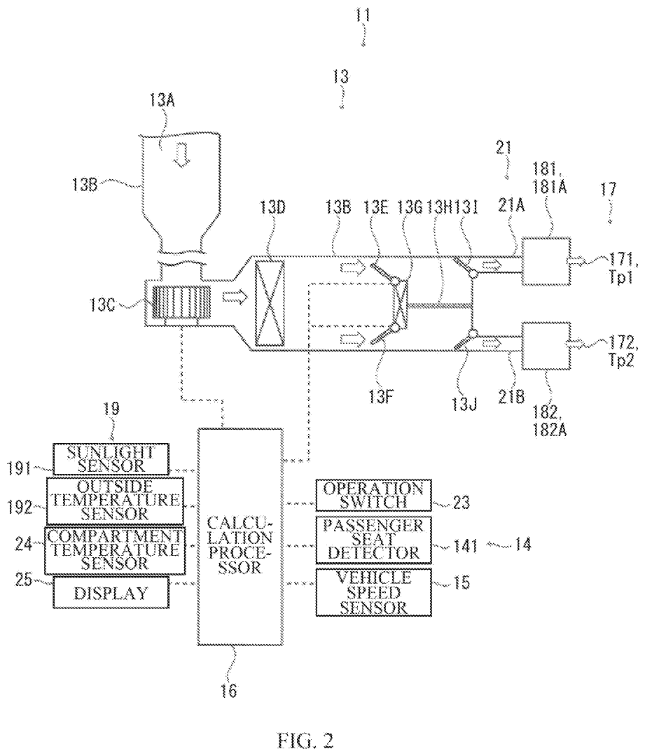

The air conditioner 13 may generate first air-conditioning air 171 and second air-conditioning air 172 by conditioning air supplied to the vehicle compartment 22. A configuration example of the air conditioner 13 will be described later with reference to FIG. 2.

The occupant detector 14 may detect whether the occupant 20 is seated (present) in any of the driver's seat 121A and the passenger seat 122A. The occupant detector 14 may include at least a passenger seat detector 141. The passenger seat detector 141 may be a sensor configured to detect whether the occupant 20 is present in the passenger seat 122A. For example, the passenger seat detector 141 may be configured to detect whether the occupant 20 is seated in the passenger seat 122A. The occupant detector 14 may also be provided at each of the rear seat 123 and the rear seat 124. In one example, the occupant detector 14 may include a strain sensor that detects an amount of a strain of a support supporting the seat 12 from below. In another example, the occupant detector 14 may include an imaging device such as a camera that captures an image of the occupant 20 in each seat 12 inside the vehicle compartment 22. In still another example, the occupant detector 14 may include any of a sensor that detects a seatbelt fastened state, a sensor that detects opening and closing of a door, and a determination based on a temperature adjustment operation history.

The air-conditioning air outlet 18 may be a cavity or an opening from which air-conditioning air conditioned by the air conditioner 13 is to be sent out into the vehicle compartment 22. The air-conditioning air outlet 18 may include a first outlet 181 and a second outlet 182. For example, the first outlet 181 may be a driver's seat outlet 181A and the second outlet 182 may be a passenger seat outlet 182A. Two driver's seat outlets 181A may be provided on the front side of the driver's seat 121A, and the first air-conditioning air 171 to be described later may be sent out from the two driver's seat outlets 181A into the vehicle compartment 22. Two passenger seat outlets 182A may be provided on the front side of the passenger seat 122A, and the second air-conditioning air 172 to be described later may be sent out from the two passenger seat outlets 182A into the vehicle compartment 22. The air-conditioning air outlet 18 may further include a rear seat outlet 183A as a third outlet 183. The rear seat outlet 183A may be disposed at a position that is on the front side of the rear seat 123 and the rear seat 124 and in the middle in the left-right direction. From the rear seat outlet 183A, air-conditioning air conditioned by the air conditioner 13 may be sent out toward the rear seat 123 and the rear seat 124.

The calculation processor 16 may include, for example, a semiconductor device including, without limitation, a central processing unit (CPU). The calculation processor 16 may effectively perform focused air conditioning of a region around the driver's seat 121A by changing an operation of the vehicle air conditioning apparatus 11 based on a seated situation of the occupant 20, as will be described later. As used herein, “air conditioning” may include heating and cooling, and may sometimes be referred to as “temperature adjustment”.

FIG. 2 is a schematic diagram illustrating a configuration of the vehicle air conditioning apparatus 11. In FIG. 2, a flow of air inside the vehicle air conditioning apparatus 11 is indicated by arrows. This is also applicable to other drawings.

The vehicle air conditioning apparatus 11 may include, for example, the air conditioner 13 and the calculation processor 16. The calculation processor 16 may control an air conditioning operation to be performed by the air conditioner 13. The vehicle air conditioning apparatus 11 may be configured to perform air conditioning of the vehicle compartment 22 by performing temperature adjustment on air introduced from an outside of the vehicle 10 or from the vehicle compartment 22 and sending air-conditioning air 17 at the adjusted temperature out into the vehicle compartment 22. An operation of each device in the air conditioner 13 may be controlled by the calculation processor 16.

The air conditioner 13 may include an air conditioner duct 13B, inside which each of the devices included in the air conditioner 13 may be disposed. The air conditioner duct 13B may be a pipe-shaped member including a material such as a synthesized resin. The air conditioner duct 13B may have an air intake 13A on a most upstream side of a flow of the air-conditioning air 17. A most downstream side of the air conditioner duct 13B may be coupled to a duct 21 which will be described later.

Inside the air conditioner duct 13B, for example, the air intake 13A, a blower 13C, a cooling heat exchanger 13D, a damper 13E, a damper 13F, a heating heat exchanger 13G, a partition 13H, a damper 13I, and a damper 13J may be provided from the upstream side of the flow of the air-conditioning air 17.

The blower 13C may be rotated by driving force of an unillustrated motor to send the air-conditioning air 17. Controlling a rotational speed of the blower 13C may allow for adjustment of an air amount of the air-conditioning air 17.

The cooling heat exchanger 13D may include a device that cools air flowing inside the air conditioner duct 13B. For example, the cooling heat exchanger 13D may include an evaporator in a refrigeration cycle. The cooling heat exchanger 13D may include any device other than the evaporator, for example, a Peltier device.

The heating heat exchanger 13G may include a device that heats the air flowing inside the air conditioner duct 13B. For example, the heating heat exchanger 13G may include a heat core that heats the air-conditioning air 17 by exchanging heat with a coolant of an engine. The heating heat exchanger 13G may include any device other than the heat core, for example, a condenser in a refrigeration cycle or a Peltier device.

The partition 13H may be a plate-shaped member that partitions a space inside the air conditioner duct 13B on the downstream side of the heating heat exchanger 13G. The partition 13H may partition an airflow path on the downstream side of the heating heat exchanger 13G into a region on a driver's seat duct 21A side (an upper portion in the paper plane of FIG. 2) and a region on a passenger seat duct 21B side (a lower portion in the paper plane of FIG. 2).

The duct 21 may be a pipe that is coupled to an end of the air conditioner duct 13B on the downstream side and guides the air-conditioning air 17. The duct 21 may include a driver's seat duct 21A and a passenger seat duct 21B. The duct 21 may also include a duct leading to a defroster outlet and a duct leading to an outlet provided under the occupant's feet.

The driver's seat duct 21A may be a pipe coupling the air conditioner duct 13B of the air conditioner 13 and the driver's seat outlet 181A to each other.

The passenger seat duct 21B may be a pipe coupling the air conditioner duct 13B of the air conditioner 13 and the passenger seat outlet 182A to each other.

The driver's seat outlet 181A may be an opening that is provided in the vehicle compartment 22 and from which the first air-conditioning air 171 conditioned to be at the first temperature Tp1 is to be sent out into the vehicle compartment 22.

The passenger seat outlet 182A may be an opening that is provided in the vehicle compartment 22 and from which the second air-conditioning air 172 conditioned to be at the second temperature Tp2 is to be sent out into the vehicle compartment 22.

The damper 13E may be a plate-shaped member disposed on the upstream side of the driver's seat duct 21A and provided in the vicinity of the heating heat exchanger 13G. The damper 13E may be opened and closed by a motor controlled by the calculation processor 16. Adjusting an opening degree of the damper 13E may change a ratio of air passing through the heating heat exchanger 13G to thereby adjust the temperature of the first air-conditioning air 171 to be sent out from the first outlet 181.

The damper 13F may be a plate-shaped member disposed on the upstream side of the passenger seat duct 21B and provided in the vicinity of the heating heat exchanger 13G. The damper 13F may be opened and closed by a motor controlled by the calculation processor 16. Adjusting an opening degree of the damper 13F may change the ratio of the air passing through the heating heat exchanger 13G to thereby adjust the temperature of the second air-conditioning air 172 to be sent out from the second outlet 182.

The damper 13I may be a plate-shaped member disposed in the vicinity of a border between the air conditioner duct 13B and the driver's seat duct 21A. The damper 13I may be opened and closed by a motor controlled by the calculation processor 16. Adjusting an opening degree of the damper 13I may allow for adjustment of an air amount of the first air-conditioning air 171 to be sent out from the first outlet 181.

The damper 13J may be a plate-shaped member disposed in the vicinity of a border between the air conditioner duct 13B and the passenger seat duct 21B. The damper 13J may be opened and closed by a motor controlled by the calculation processor 16. Adjusting an opening degree of the damper 13J may allow for adjustment of an air amount of the second air-conditioning air 172 to be sent out from the second outlet 182.

As described above, the calculation processor 16 may serve as a calculator including, for example, the CPU. The calculation processor 16 may also be referred to as an electronic control unit (ECU) or an air-conditioning ECU. The calculation processor 16 may include an input terminal and an output terminal. Coupled to the input terminal of the calculation processor 16 may be, for example, a vehicle outside environment detector 19. Coupled to the output terminal of the calculation processor 16 may be, for example, the air conditioner 13. The calculation processor 16 may read a predetermined program from an unillustrated storage, perform a predetermined calculation process based on information such as information supplied from, for example, the vehicle outside environment detector 19, and output an electric signal to control, for example, the air conditioner 13. The storage may include, for example, a semiconductor memory. An example of the control of the air conditioner 13 to be performed by the calculation processor 16 will be described later.

The vehicle outside environment detector 19 may include a sunlight sensor 191 and an outside temperature sensor 192.

The sunlight sensor 191 may measure sunlight from the sun outside the vehicle 10, and may transmit a signal indicating the magnitude of the sunlight to the calculation processor 16.

The outside temperature sensor 192 may measure a temperature outside the vehicle 10, and may transmit a signal indicating the height of the temperature to the calculation processor 16.

A compartment temperature sensor 24 may measure a temperature in the vehicle compartment 22, and may transmit a signal indicating the height of the temperature to the calculation processor 16.

An operation switch 23 may be disposed at and in the vicinity of a dashboard of the vehicle 10. The operation switch 23 may give an instruction to the calculation processor 16 by being operated by the occupant 20. The operation switch 23 may be adopted to individual setting of a temperature in the vicinity of the driver's seat 121A and a temperature in the vicinity of the passenger seat 122A.

The passenger seat detector 141 may detect whether the occupant 20 is present in the passenger seat 122A as described above, and may transmit a signal indicating a result of the detection to the calculation processor 16.

A vehicle speed sensor 15 may transmit, to the calculation processor 16, a signal indicating a vehicle speed when the vehicle 10 is traveling.

A display 25 may include, for example, a liquid crystal panel disposed, for example, at or in the vicinity of the dashboard of the vehicle 10. The display 25 may display information regarding air conditioning, such as the first temperature Tp1 and the second temperature Tp2.

An air-conditioning operation to be performed by the air conditioner 13 will be described. When the air conditioning of the vehicle compartment 22 described above is to be performed based on, for example an operation performed on the operation switch 23, first, the blower 13C may rotate to generate the air-conditioning air 17. Air from the outside of the vehicle 10 or from the vehicle compartment 22 may be introduced through the air intake 13A. The introduced air may be conditioned by the cooling heat exchanger 13D or the heating heat exchanger 13G. When the air conditioner 13 performs cooling, the air may be cooled by the cooling heat exchanger 13D. When the air conditioner 13 performs heating, the air may be heated by the heating heat exchanger 13G. The conditioned first air-conditioning air 171 may flow through the driver's seat duct 21A and may be sent out from the driver's seat outlet 181A into the vehicle compartment 22. The conditioned second air-conditioning air 172 may flow through the passenger seat duct 21B and may be sent out from the passenger seat outlet 182A into the vehicle compartment 22. As described above, adjusting the opening degrees of the damper 13E and the damper 13F may allow for adjustment of the temperatures of the first air-conditioning air 171 and the second air-conditioning air 172, respectively. In addition, adjusting the opening degrees of the damper 13I and the damper 13J may allow for adjustment of the air amounts of the first air-conditioning air 171 and the second air-conditioning air 172, respectively.

The air conditioner 13 having the above-described configuration may be configured to perform the air conditioning of the vehicle compartment 22 in a plurality of air-conditioning modes based on an operation performed by the occupant 20 or a determination performed by the calculation processor 16. For example, the air-conditioning modes may include an all-seat air-conditioning mode, a front-seat air-conditioning mode, a focused air-conditioning mode, and a driver's seat air-conditioning mode. In one embodiment, the front-seat air-conditioning mode may serve as a “first mode”. In one embodiment, the focused air-conditioning mode may serve as a “second mode”. Each of the air-conditioning modes will be described below with reference to the drawings. In each of the drawings, a hatched region may be a region in which an air-conditioning effect is notable.

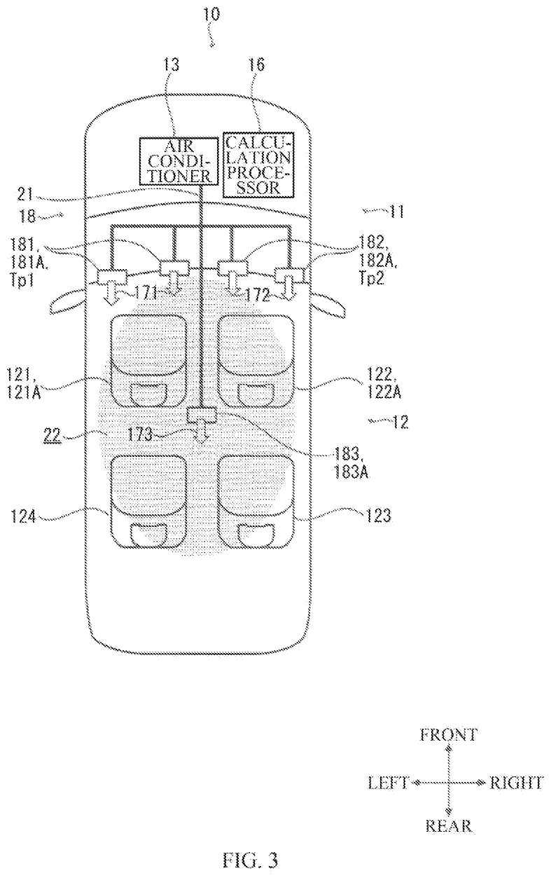

FIG. 3 is a diagram illustrating an operation to be performed in the all-seat air-conditioning mode, viewed from the top. In this example, the first air-conditioning air 171, the second air-conditioning air 172, and the third air-conditioning air 173 may be sent out into the vehicle compartment 22 from the driver's seat outlets 181A, the passenger seat outlets 182A, and the rear seat outlet 183A, respectively. Air conditioning in the vicinity of the driver's seat 121A may be performed by the first air-conditioning air 171, air conditioning in the vicinity of the passenger seat 122A may be performed by the second air-conditioning air 172, and air conditioning in the vicinity of the rear seat 123 and the rear seat 124 may be performed by the third air-conditioning air 173. Air conditioning in the vicinities of all of the seats 12 may thus be performed inside the vehicle compartment 22. The all-seat air-conditioning mode may be executed by the occupant 20 described above operating the operation switch 23. For example, the all-seat air-conditioning mode may also be executed based on an instruction given from the calculation processor 16 when the occupant detector 14 detects that the occupants 20 are present in all the seats 12. For example, the all-seat air-conditioning mode may be executed also when no occupant 20 is seated in the passenger seat 122A and the occupant 20 is seated in one of or each of the rear seat 123 and the rear seat 124.

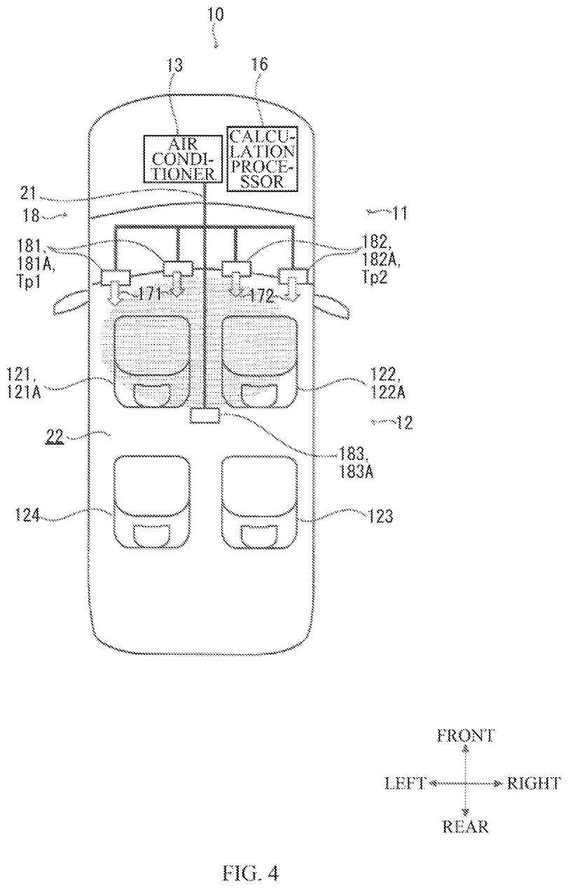

FIG. 4 is a diagram illustrating an operation to be performed in the front-seat air-conditioning mode, viewed from the top. In this example, the first air-conditioning air 171 and the second air-conditioning air 172 may be sent out into the vehicle compartment 22 from the driver's seat outlets 181A and the passenger seat outlets 182A, respectively. No air may be sent out from the rear seat outlet 183A. The air conditioning in the vicinity of the driver's seat 121A may be performed by the first air-conditioning air 171, and the air conditioning in the vicinity of the passenger seat 122A may be performed by the second air-conditioning air 172. The air conditioning in the vicinities of the driver's seat 121A and the passenger seat 122A may thus be performed inside the vehicle compartment 22. The front-seat air-conditioning mode may be executed by the occupant 20 described above operating the operation switch 23. For example, the front-seat air-conditioning mode may be executed based on an instruction given from the calculation processor 16 when the occupant detector 14 detects that the occupant 20 is present in the passenger seat 122A and no occupant 20 is present in the rear seat 123 or the rear seat 124. For example, whether the occupant 20 is in any of the rear seat 123 and the rear seat 124 may be detected not only by the occupant detector 14 but also based on information regarding opening and closing of rear-seat doors within a predetermined period of time.

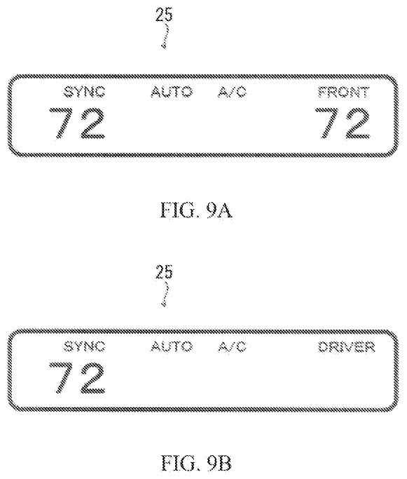

In the example embodiment, the first temperature Tp1 and the second temperature Tp2 may be individually set. For example, a temperature felt by a first occupant seated in the first seat 121 and a temperature felt by a second occupant seated in the second seat 122 may be different from each other. In such a case, if air-conditioning is performed evenly for the vicinity of the driver's seat 121A and the vicinity of the passenger seat 122A, one of the first occupant and the second occupant can feel the air-conditioning state uncomfortable. To address this, the example embodiment may be configured to set the first temperature Tp1 and the second temperature Tp2 to different temperatures by the occupant operating the operation switch 23. This makes it possible to perform air conditioning of a region around the first seat 121 and a region around the second seat 122 to allow a temperature in the region around the first seat 121 and a temperature in the region around the second seat 122 to be different from each other, allowing both the first occupant in the first seat 121 and the second occupant in the second seat 122 to feel comfortable. Further, as illustrated in FIG. 9A, the first temperature Tp1 and the second temperature Tp2 may each be displayed on the display 25 described above. Referring to FIG. 9A, the number displayed on the left side of the display 25 may be the first temperature Tp1, and the number displayed on the right side of the display 25 may be the second temperature Tp2.

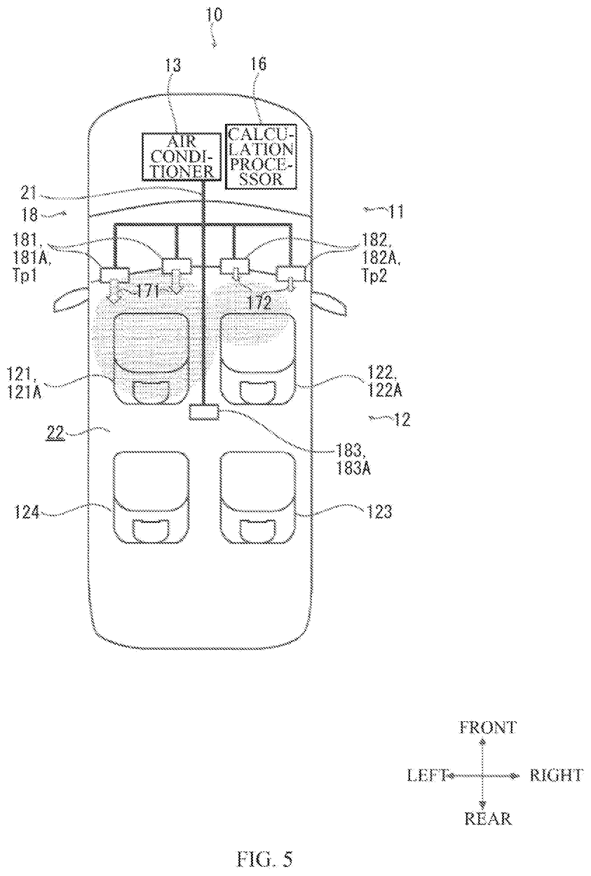

FIG. 5 is a diagram illustrating an operation to be performed in the focused air-conditioning mode, viewed from the top. In this example, the focused air-conditioning mode may be a mode in which, when the occupant 20 is present in the driver's seat 121A, no occupant 20 is present in the passenger seat 122A, and no occupant 20 is present in the rear seat 123 or the rear seat 124, the second air-conditioning air 172 is sent weakly as if the second air-conditioning air 172 is leaking out while the first air-conditioning air 171 is sent to thereby execute focused air conditioning that achieves enhanced air conditioning in the vicinity of the driver's seat 121A.

In this example, as with the front-seat air-conditioning mode described above, the first air-conditioning air 171 at the first temperature Tp1 may be sent out from the driver's seat outlets 181A into the vehicle compartment 22. The air conditioning in the vicinity of the driver's seat 121A may be performed by the first air-conditioning air 171. In the focused air-conditioning mode, the second air-conditioning air 172 at the second temperature Tp2 may be sent out from the passenger seat outlets 182A. In this case, a flow amount of the second air-conditioning air 172 may be reduced as compared with that in the front-seat air-conditioning mode to weakly send the second air-conditioning air 172. This makes it possible to reduce energy consumption in the focused air conditioning.

The air conditioning in a region close to the driver's seat 121A may be performed by the first air-conditioning air 171, and the air conditioning in the vicinity of the driver's seat 121A may be enhanced by the second air-conditioning air 172. For example, the focused air-conditioning mode may be executed by the occupant 20 described above operating the operation switch 23, or based on an instruction given from the calculation processor 16. For example, the focused air-conditioning mode may be executed based on an instruction given from the calculation processor 16 when the occupant detector 14 detects that the occupant 20 is present in the driver's seat 121A but not in other seats.

As will be described later, when the focused air conditioning is executed, the second temperature Tp2 of the second air-conditioning air 172 may be changed to a temperature that allows for an increase in the air-conditioning effect.

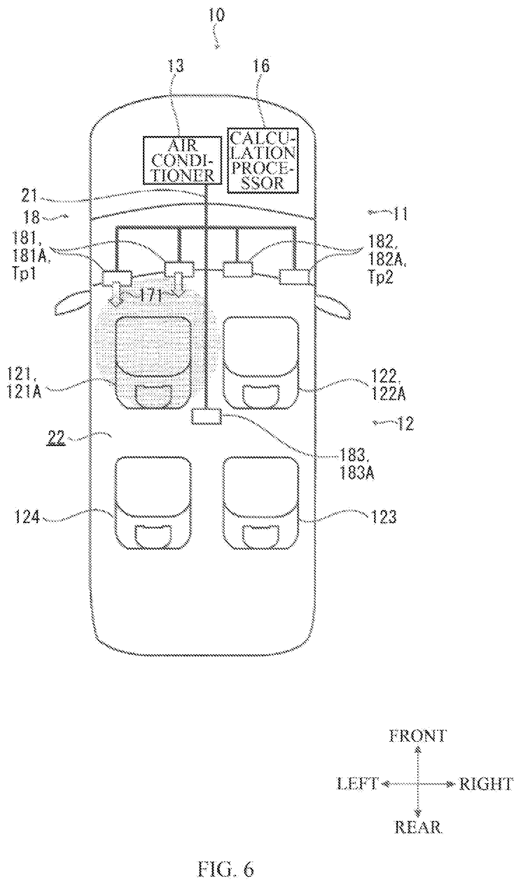

FIG. 6 is a diagram illustrating an operation to be performed in the driver's seat air-conditioning mode, viewed from the top. In this example, the first air-conditioning air 171 may be sent out simply from the driver's seat outlets 181A into the vehicle compartment 22. No air may be sent out from the passenger seat outlets 182A or the rear seat outlet 183A. The air conditioning in the vicinity of the driver's seat 121A may be performed by the first air-conditioning air 171. The driver's seat air-conditioning mode may be executed by the occupant 20 described above operating the operation switch 23. For example, the driver's seat air-conditioning mode may be executed based on an instruction given from the calculation processor 16 when the occupant detector 14 detects that the occupant 20 is present in the driver's seat 121A but not in other seats. In this example, the driver's seat air-conditioning mode may be executed in a situation in which an environment load is very low and the second air-conditioning air 172 is not to be sent weakly as if the second air-conditioning air 172 is leaking out in the focused air-conditioning mode, i.e., a situation where a sufficient air-conditioning effect is obtainable simply by the first air-conditioning air 171.

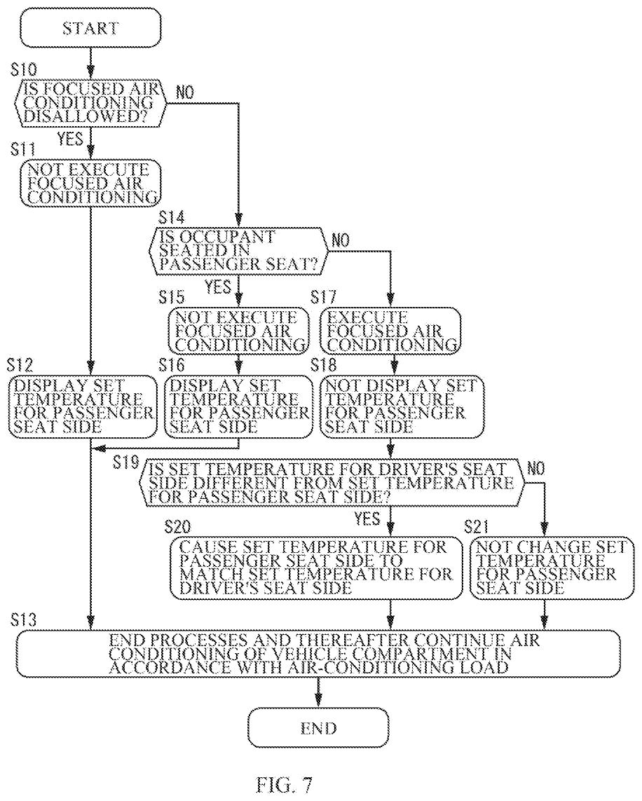

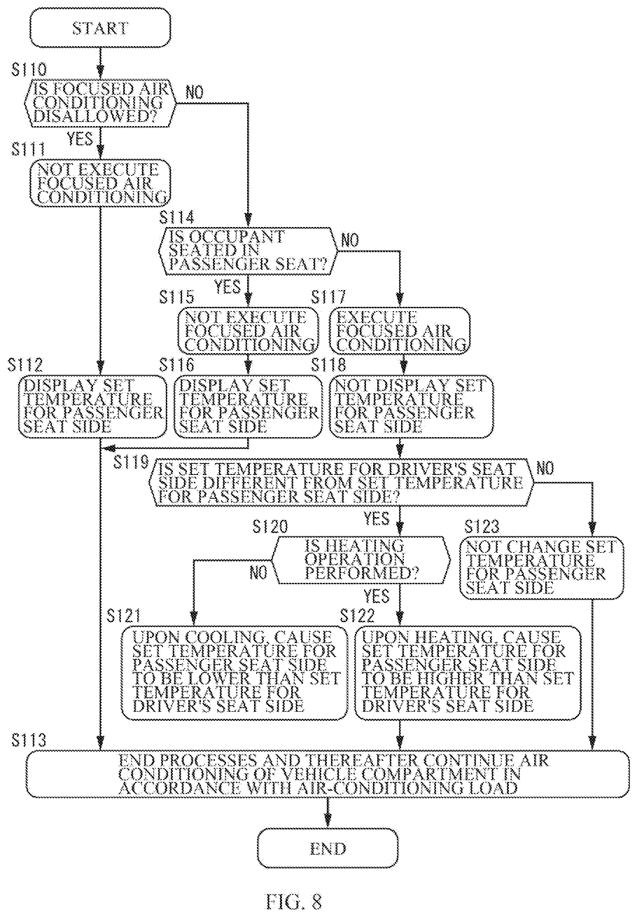

Referring to FIGS. 7 and 8, an operation to be performed by the vehicle air conditioning apparatus 11 in the focused air-conditioning mode will be described in detail. FIG. 7 is a flowchart illustrating an operation in a case where the second temperature Tp2 is caused to match the first temperature Tp1 when the focused air conditioning is to be executed. FIG. 8 is a flowchart illustrating an operation in a case where the second temperature Tp2 is not caused to match the first temperature Tp1 when the focused air conditioning is to be executed.

Based on FIG. 7 and with reference to the diagrams described above, the operation to be performed by the vehicle air conditioning apparatus 11 in the focused air-conditioning mode will be described in detail.

First, when the vehicle 10 is traveling, the calculation processor 16 of the vehicle air conditioning apparatus 11 may perform air conditioning of the vehicle compartment 22. For example, when the temperature outside the vehicle 10 detected by the vehicle outside environment detector 19 is high, the calculation processor 16 may cool the vehicle compartment 22. For example, when the temperature outside the vehicle 10 detected by the vehicle outside environment detector 19 is low, the calculation processor 16 may heat the vehicle compartment 22. For example, switching between heating and cooling may be performed based on an operation performed by a user. In addition, for example, a set temperature for the vehicle compartment 22 may be changed manually by the user.

In step S10, the calculation processor 16 may determine whether the focused air conditioning is disallowed. For example, if the focused air conditioning is disallowed by a button operation performed by the user, the focused air conditioning and the driver's seat air conditioning may not be executable. Note that FIG. 9A illustrates a display state in the front-seat air-conditioning mode as an example, and in the all-seat air-conditioning mode, “ALL” may be displayed instead of “FRONT” on an upper-right side.

If the focused air conditioning is disallowed in step S10 (step S10: YES), the calculation processor 16 may proceed to step S11.

If the focused air conditioning is allowed in step S10 (step S10: NO), for example, if the vehicle air conditioning apparatus 11 is operable in a normal state, the calculation processor 16 may proceed to step S14.

In step S11, the calculation processor 16 may not execute the focused air conditioning described above.

In step S12, the calculation processor 16 may display an air-conditioning set temperature for the passenger seat 122A side, for example, the second temperature Tp2 described above. This display state is illustrated in FIG. 9A. Here, a portion of the display 25 including a liquid crystal display is illustrated. The display 25 may display the first temperature Tp1 that is the set temperature for the driver's seat 121A on the left side and may display the second temperature Tp2 that is the set temperature for the passenger seat 122A side on the right side.

In step S13, the calculation processor 16 may end the flow of the processes to be performed in the focused air conditioning. Thereafter, based on an instruction given from the vehicle air conditioning apparatus 11, the calculation processor 16 may continue the air conditioning of the vehicle compartment 22 in accordance with an air-conditioning load detected by the vehicle outside environment detector 19. For example, the calculation processor 16 may continue the air conditioning of the vehicle compartment 22 until the occupant 20 finishes driving the vehicle 10 and gets off the vehicle 10.

In step S14, the calculation processor 16 may determine whether the occupant 20 is seated in the passenger seat 122A. Referring to FIG. 1, for example, the calculation processor 16 may check whether the occupant 20 is present in the passenger seat 122A based on a result of the detection performed by the passenger seat detector 141. The determination as to whether the occupant 20 is present in the passenger seat 122A may be performed by the calculation processor 16 based on, for example, a result of a detection performed by a seat belt sensor, presence and absence of an operation of adjusting the temperature on the passenger seat 122A side, or opening and closing of the door near the passenger seat 122A.

If the occupant 20 is seated in the passenger seat 122A (step S14: YES), the calculation processor 16 may proceed to step S15.

If no occupant 20 is seated in the passenger seat 122A (step S14: NO), the calculation processor 16 may proceed to step S17.

In step S15, the calculation processor 16 may not execute the focused air conditioning. That is, referring to FIG. 4, the occupants 20 may be present in both the driver's seat 121A and the passenger seat 122A. Accordingly, for example, the first air-conditioning air 171 conditioned to be at the first temperature Tp1 may be sent out from the first outlets 181 toward the driver's seat 121A. Meanwhile, the second air-conditioning air 172 conditioned to be at the second temperature Tp2 may be sent out from the second outlets 182 toward the passenger seat 122A. This makes it possible to achieve comfortable air conditioning of the region around the driver's seat 121A and the region around the passenger seat 122A. Here, the first temperature Tp1 and the second temperature Tp2 may be substantially the same as each other or may be different from each other.

In step S16, the calculation processor 16 nay display the air-conditioning set temperature for the passenger seat 122A side, for example, the second temperature Tp2 described above. Such display may be substantially similar to that in step S12 described above.

In step S17, the calculation processor 16 may execute the focused air conditioning. That is, the calculation processor 16 may execute the operation in the focused air-conditioning mode described above with reference to FIG. 5. In some cases, the calculation processor 16 may execute the operation in the driver's seat air-conditioning mode described with reference to FIG. 6 in step S17 depending on the environment load.

In step S18, as illustrated in FIG. 9B, the calculation processor 16 may not display the air-conditioning set temperature for the passenger seat 122A side, for example, the second temperature Tp2, on the display 25. For example, when executing the focused air conditioning, the calculation processor 16 may sometimes change the second temperature Tp2 to a higher temperature or a lower temperature. In such a case, if the changed second temperature Tp2 is displayed on the display 25, the occupant 20 may feel worried or anxious. To avoid such a situation, even if the second temperature Tp2 is changed, information indicating such a change may not be displayed on the display 25 in the example embodiment. Referring to FIG. 9B, in the normal air-conditioning operation, the number indicating the second temperature Tp2 may be displayed in a right portion of the display 25; however, the number may not be displayed in the right portion of the display 25 in step S18.

In step S19, the calculation processor 16 may compare the set temperatures with each other. For example, the calculation processor 16 may compare the first temperature Tp1 that is the set temperature for the driver's seat 121A side and the second temperature Tp2 that is the set temperature for the passenger seat 122A side with each other, and may determine whether the first temperature Tp1 and the second temperature Tp2 are different from each other. For example, a certain threshold may be set in advance, and in step S19, the calculation processor 16 may determine that the first temperature Tp1 and the second temperature Tp2 are different from each other if a difference between the first temperature Tp1 and the second temperature Tp2 is greater than or equal to the threshold.

If the first temperature Tp1 and the second temperature Tp2 are different from each other (step S19: YES), the calculation processor 16 may proceed to step S20.

If the first temperature Tp1 and the second temperature Tp2 are not different from each other (step S19: NO), the calculation processor 16 may proceed to step S21.

In step S20, the calculation processor 16 may cause the second temperature Tp2 to match the first temperature Tp1. For example, if the vehicle air conditioning apparatus 11 is performing cooling for the occupant 20 and the second temperature Tp2 is higher than the first temperature Tp1, the calculation processor 16 may decrease the second temperature Tp2 to the first temperature Tp1. If the vehicle air conditioning apparatus 11 is performing heating for the occupant 20 and the second temperature Tp2 is lower than the first temperature Tp1, the calculation processor 16 may increase the second temperature Tp2 to the first temperature Tp1. After changing the set temperature in this manner, the air conditioning of the region around the driver's seat 121A may be performed by the first air-conditioning air 171 conditioned to be at the first temperature Tp1 as described above with reference to FIG. 5. In addition, auxiliary air conditioning of the vicinity of the driver's seat 121A may be performed by the second air-conditioning air 172 conditioned to be at the second temperature Tp2. This makes it possible to increase the effect of enhancing the air conditioning of the region around the driver's seat 121A by the second air-conditioning air 172. After the process in step S20 is ended, the calculation processor 16 may proceed to step S13 described above and may continue the air conditioning of the vehicle compartment 22 by the vehicle air conditioning apparatus 11.

In step S21, the calculation processor 16 may not change the second temperature Tp2. In this state, while the air conditioning of the region around the driver's seat 121A is performed by the first air-conditioning air 171, the auxiliary air conditioning of the vicinity of the driver's seat 121A may be performed by the second air-conditioning air 172, as illustrated in FIG. 5. This makes it possible to enhance the air conditioning of the region around the driver's seat 121A by the second air-conditioning air 172. After the process in step S21 is ended, the calculation processor 16 may proceed to step S13 described above and may continue the air conditioning of the vehicle compartment 22 by the vehicle air conditioning apparatus 11.

Thereafter, when the vehicle 10 is stopped and the occupant 20 ends each operation of the vehicle 10, the calculation processor 16 may end the air conditioning of the vehicle compartment 22 by the vehicle air conditioning apparatus 11.

Referring to a flowchart illustrated in FIG. 8, a description is provided of an air conditioning method according to another example embodiment using the vehicle air conditioning apparatus 11. In the air conditioning method illustrated in FIG. 8, the temperature may be changed more radically than in the air conditioning method illustrated in FIG. 7, making it possible to increasing the effect of the focused air conditioning.

The flowchart illustrated in FIG. 8 may be similar in part to the flowchart illustrated in FIG. 7. For example, operations in steps S110 to S119 and S123 described in FIG. 8 may be similar to those in steps S10 to S19 and S21 described in FIG. 7, respectively.

Respective operations in steps in and after S120 in FIG. 8 will be described below.

In step S120, the calculation processor 16 may determine whether the vehicle air conditioning apparatus 11 is performing a heating operation.

If the vehicle air conditioning apparatus 11 is performing the heating operation (step S120: YES), the calculation processor 16 may proceed to step S122.

If the vehicle air conditioning apparatus 11 is performing the cooling operation (step S120: NO), the calculation processor 16 may proceed to step S121.

In step S121, upon cooling, the calculation processor 16 may cause the second temperature Tp2 that is the set temperature for the passenger seat 122A side to be lower than the first temperature Tp1 that is the set temperature for the driver's seat 121A side. Referring to FIG. 5, this may make it possible to cause the temperature of the second air-conditioning air 172 to be lower than the first air-conditioning air 171 upon the cooling. It is therefore possible to more effectively cool the vicinity of the driver's seat 121A by the second air-conditioning air 172.

In step S122, upon heating, the calculation processor 16 may cause the second temperature Tp2 that is the set temperature for the passenger seat 122A side to be higher than the first temperature Tp1 that is the set temperature for the driver's seat 121A side. Referring to FIG. 5, this may make it possible to cause the temperature of the second air-conditioning air 172 to be higher than the first air-conditioning air 171 upon the heating. It is therefore possible to more effectively heat the vicinity of the driver's seat 121A by the second air-conditioning air 172.

The air conditioning method according to the other example embodiment using the vehicle air conditioning apparatus 11 has been described above. The focused air conditioning according to the other example embodiment illustrated in FIG. 8 makes it possible to further increase an auxiliary air conditioning effect based on the second temperature Tp2. It is therefore possible to more quickly and more effectively make the atmosphere around the driver's seat 121A comfortable.

Some examples of the technical idea derived from the example embodiments described above will be described below with example effects thereof.

A vehicle air conditioning apparatus according to an example embodiment of the disclosure includes a seat, an air conditioner, an occupant detector, an air-conditioning air outlet, and a calculation processor. The seat includes a first seat and a second seat. The air conditioner is configured to generate first air-conditioning air and second air-conditioning air by conditioning air supplied to a vehicle compartment. The occupant detector is configured to detect whether an occupant is present in the second seat. The air-conditioning air outlet includes a first outlet that is provided in the vicinity of the first seat and from which the first air-conditioning air is sent out into the vehicle compartment and a second outlet that is provided in the vicinity of the second seat and from which the second air-conditioning air is sent out into the vehicle compartment. The calculation processor is configured to, when determining that the occupant is not present in the second seat based on an output from the occupant detector, send out the first air-conditioning air from the first outlet into the vehicle compartment and send out the second air-conditioning air from the second outlet into the vehicle compartment. The first air-conditioning air is conditioned to be at a first temperature. The second air-conditioning air is conditioned to be at a second temperature set to increase an air conditioning effect. According to the vehicle air conditioning apparatus of the example embodiment of the disclosure, it is possible to effectively perform air conditioning of the vicinity of the seat in which the occupant is present. For example, in the example embodiment of the disclosure, if no occupant is present in the second seat, first, the first air-conditioning air may be sent out into the vehicle compartment from the first outlet provided in the vicinity of the first seat. In addition, the second air-conditioning air having an increased air-conditioning effect may be sent out from the second outlet into the vehicle compartment. This makes it possible to effectively perform air conditioning of the vicinity of the first seat in the vehicle compartment. It is therefore possible to improve comfort of the occupant present in the first seat and to reduce energy to be used in air conditioning.

Further, in the vehicle air conditioning apparatus according to the example embodiment of the disclosure, the calculation processor may be configured to, when the vehicle compartment is to be cooled, cause the second temperature of the second air-conditioning air to be lower than or equal to the first temperature of the first air-conditioning air. According to the vehicle air conditioning apparatus of the example embodiment of the disclosure, when the occupant is present in the first seat and no occupant is present in the second seat, it is possible to effectively cool a region around the first seat and improve coolness to be felt by the occupant.

Further, in the vehicle air conditioning apparatus according to the example embodiment of the disclosure, the calculation processor may be configured to, when the vehicle compartment is to be heated, cause the second temperature of the second air-conditioning air to be higher than or equal to the first temperature of the first air-conditioning air. According to the vehicle air conditioning apparatus of the example embodiment of the disclosure, when the occupant is present in the first seat and no occupant is present in the second seat, it is possible to effectively heat the region around the first seat and improve comfort to be felt by the occupant.

In addition, the vehicle air conditioning apparatus according to the example embodiment of the disclosure may further include a vehicle outside environment detector configured to detect an environment outside the vehicle. In such a vehicle air conditioning apparatus, the calculation processor may set the second temperature based on the environment outside the vehicle detected by the vehicle outside environment detector. According to the vehicle air conditioning apparatus of the example embodiment of the disclosure, it is possible to more effectively perform the air conditioning of the region around the first seat by taking into consideration the environment outside the vehicle when setting the second temperature.

Further, in the vehicle air conditioning apparatus according to the example embodiment of the disclosure, the first seat may include a driver's seat. The second seat may include a passenger seat. The calculation processor may be configured to execute a first mode in which air conditioning is performed to cause a temperature in a region around the driver's seat and a temperature in a region around the passenger seat to be different from each other by individually setting the first temperature and the second temperature and sending out the first air-conditioning air and the second air-conditioning air. The calculation processor may be configured to execute a second mode in which, when the occupant is not present in the passenger seat, the first air-conditioning air is sent out and the second air-conditioning air is sent out more weakly than in the first mode. The calculation processor may be configured to, upon transition from the first mode to the second mode, change the second temperature of the second air-conditioning air to a temperature that increases the air conditioning effect. According to the vehicle air conditioning apparatus of the example embodiment of the disclosure, for example, even when the second temperature is set to a relatively high temperature when the vehicle air conditioning apparatus is performing a cooling operation, changing the second temperature to a lower temperature upon the transition from the first mode to the second mode makes it possible to increase an effect of cooling a region around the driver's seat by the second air-conditioning air.

In addition, the vehicle air conditioning apparatus according to the example embodiment of the disclosure may further include a display on which an air conditioning state of the vehicle compartment is to be displayed. The calculation processor may be configured to, when the second temperature is changed, refrain from causing information to be displayed. The information may indicate that the second temperature is changed. According to the vehicle air conditioning apparatus of the example embodiment of the disclosure, it is possible to help to prevent the occupant from being unexpectedly worried when the second temperature is changed.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

Referring to FIG. 1, for example, the driver's seat 121A has been described as an example of the first seat 121 for which the focused air conditioning is performed. However, the first seat 121 may be any other seat.

Referring to FIG. 2, for example, the passenger seat 122A has been described as an example of the second seat 122. However, the second seat 122 may be any other seat.

According to a vehicle air conditioning apparatus of an example embodiment of the disclosure, it is possible to effectively perform air conditioning of the vicinity of a seat in which an occupant is present. For example, according to the example embodiment of the disclosure, when no occupant is present in a second seat, first, first air-conditioning air may be sent out into a vehicle compartment from a first outlet provided in the vicinity of the first seat. In addition, second air-conditioning air may be sent out from a second outlet into the vehicle compartment. The second air-conditioning air may have a greater air-conditioning effect. This makes it possible to perform focused air conditioning of the vicinity of the first seat inside the vehicle compartment. It is therefore possible to improve comfort to be felt by the occupant present in the first seat and to reduce energy to be used in the air conditioning.

The calculation processor 16 illustrated in FIG. 2 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the calculation processor 16 illustrated in FIG. 2. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the calculation processor 16 illustrated in FIG. 2.

1. A vehicle air conditioning apparatus comprising:
a seat comprising a first seat and a second seat;
an air conditioner configured to generate first air-conditioning air and second air-conditioning air by conditioning air supplied to a vehicle compartment;
an occupant detector configured to detect whether an occupant is present in the second seat;
an air-conditioning air outlet comprising a first outlet that is provided in vicinity of the first seat and from which the first air-conditioning air is to be sent out into the vehicle compartment and a second outlet that is provided in vicinity of the second seat and from which the second air-conditioning air is to be sent out into the vehicle compartment; and
a calculation processor configured to, when determining that the occupant is not present in the second seat based on an output from the occupant detector, send out the first air-conditioning air from the first outlet into the vehicle compartment and send out the second air-conditioning air from the second outlet into the vehicle compartment, the first air-conditioning air being conditioned to be at a first temperature, the second air-conditioning air being conditioned to be at a second temperature set to increase an air conditioning effect.

2. The vehicle air conditioning apparatus according to claim 1, wherein the calculation processor is configured to, when the vehicle compartment is to be cooled, cause the second temperature of the second air-conditioning air to be lower than or equal to the first temperature of the first air-conditioning air.

3. The vehicle air conditioning apparatus according to claim 1, wherein the calculation processor is configured to, when the vehicle compartment is to be heated, cause the second temperature of the second air-conditioning air to be higher than or equal to the first temperature of the first air-conditioning air.

4. The vehicle air conditioning apparatus according to claim 1, wherein
the first seat comprises a driver's seat,
the second seat comprises a passenger seat, and
the calculation processor is configured to
execute a first mode in which air conditioning is performed to cause a temperature in a region around the driver's seat and a temperature in a region around the passenger seat to be different from each other by individually setting the first temperature and the second temperature and sending out the first air-conditioning air and the second air-conditioning air,
execute a second mode in which, when the occupant is not present in the passenger seat, the first air-conditioning air is sent out and the second air-conditioning air is sent out more weakly than in the first mode, and
upon transition from the first mode to the second mode, change the second temperature of the second air-conditioning air to a temperature that increases the air conditioning effect.

5. The vehicle air conditioning apparatus according to claim 1, further comprising
a display on which an air conditioning state of the vehicle compartment is to be displayed, wherein
the calculation processor is configured to, when the second temperature is changed, refrain from causing information to be displayed, the information indicating that the second temperature is changed.

6. A vehicle air conditioning apparatus comprising:
a seat comprising a first seat and a second seat;
an air conditioner configured to generate first air-conditioning air and second air-conditioning air by conditioning air supplied to a vehicle compartment;
an occupant detector comprising a sensor, the occupant detector being configured to detect whether an occupant is present in the second seat;
an air-conditioning air outlet comprising a first outlet that is provided in vicinity of the first seat and from which the first air-conditioning air is to be sent out into the vehicle compartment and a second outlet that is provided in vicinity of the second seat and from which the second air-conditioning air is to be sent out into the vehicle compartment; and
circuitry configured to, when determining that the occupant is not present in the second seat based on an output from the occupant detector, send out the first air-conditioning air from the first outlet into the vehicle compartment and send out the second air-conditioning air from the second outlet into the vehicle compartment, the first air-conditioning air being conditioned to be at a first temperature, the second air-conditioning air being conditioned to be at a second temperature set to increase an air conditioning effect.
